(19) United States
(12) Patent Application Publication
(10) Pub. No.: US 2026/0087250 A1
(43) Pub. Date: Mar. 26, 2026

(54) GENERATIVE MODEL ASSISTED LIBRARY GENERATION AND DECONFLICTING

(71) Applicant: SAP SE, Walldorf (DE)

(72) Inventors: Volker Driesen, Heidelberg (DE); Jochen Steinmetz, Neckargemünd (DE)

(21) Appl. No.: 18/894,237

(22) Filed: Sep. 24, 2024

(51) Int. Cl. G06F 40/242; G06F 16/383

(52) U.S. Cl. CPC G06F 40/242; G06F 16/383

(57) ABSTRACT

Systems, software, and computer implemented methods for building a terminology dictionary are disclosed. A process including providing one or more documents to a generative artificial intelligence (AI) model for analysis; obtaining, using the generative AI model, a set of terms extracted from the one or more provided documents; generating, using the generative AI model, a definition for each term of the set of terms; identifying, using the generative AI model, two or more similar terms from the set of terms based on identifying semantic similarity between respective definitions of the two or more similar terms; generating, using the generative AI model, a consensus term, the definition being generated based on the respective definitions of the two or more similar terms; and providing the consensus term and the definition for the generated consensus term to store in the terminology dictionary.

### BACKGROUND

Modern projects often involve multiple teams working with complex, multi-component systems of such scale or complexity that the projects can develop their own internal terminology or jargon. In some cases, the same concepts may be described in different ways that can cause a confusion as to whether these concepts are the same, overlap, or a completely different. When internal project terminology is used during cross-project communication, miscommunication can happen as a result of misunderstood terminology or conflicting terms and can cause wasted effort and time.

### SUMMARY

The present disclosure involves systems, software, and computer implemented methods for building a terminology dictionary, the process including providing one or more documents to a generative artificial intelligence (AI) model for analysis; obtaining, using the generative AI model, a set of terms extracted from the one or more provided documents; generating, using the generative AI model, a definition for each term of the set of terms; identifying, using the generative AI model, two or more similar terms from the set of terms based on identifying semantic similarity between respective definitions of the two or more similar terms; generating, using the generative AI model, a consensus term, the definition being generated based on the respective definitions of the two or more similar terms; and providing the consensus term and the definition for the generated consensus term to store in the terminology dictionary.

Implementations can optionally include one or more of the following features.

In some instances, a term of the extracted set of terms from the one or more provided documents is associated with at least two generated definitions. The process can further include identifying, using the generative AI model, the term as a conflicting term based on identifying that the at least two generated definitions are conflicting term definitions; providing the identified conflicting terms to a user system for user review; and receiving, from the user system, a selection of a consensus term definition of the at least to generated definitions for providing the term with the consensus term definition to store in the terminology dictionary.

In some instances, the process includes identifying one or more particular documents of the one or more documents, the one or more particular documents comprising the identified conflicting term, wherein the one or more particular documents are associated with one or more definitions of the conflicting term that does not correspond to the selected consensus term definition; and providing the one or more particular documents to the user system for user review.

In some instances, obtaining the set of terms extracted from the one or more provided documents includes: sorting extracted terms from the one or more provided documents based on comparing the extracted terms with terms already stored at the terminology dictionary into a category from a group consisting of new, existing, or discarded; and determining the set of terms to be those of the extracted terms that are categorized as new. In some instances, new terms are terms that do not previously exist in the terminology dictionary, existing terms are terms that already exist in the terminology dictionary, and discarded terms are terms that are not provided for generation of a definition or considered for storing in the terminology dictionary.

In some instances, the generative AI model is a large language model.

In some instances, generating the definition for each term in the set of terms is based on the output of the generative AI model as trained on, internet search, and each term as applied in the one or more provided documents.

In some instances, the identified two or more similar terms are replaced by the consensus term in the provided documents.

The details of these and other aspects and embodiments of the present disclosure are set forth in the accompanying drawings and the description below. Other features, objects, and advantages of the disclosure will be apparent from the description, drawings, and claims.

### DESCRIPTION OF DRAWINGS

Some example embodiments of the present disclosure are illustrated by way of example and not limitation in the figures of the accompanying drawings, in which like reference numbers indicate similar elements.

FIG. 1 illustrates a schematic diagram of a system for building and storing a terminology dictionary.

FIG. 2 is a flowchart of an example process 200 for building and storing a terminology dictionary.

FIG. 3 is a flowchart of an example process 300 for building and storing a terminology dictionary.

FIG. 4 is a block diagram illustrating an example of a computer-implemented system.

### DETAILED DESCRIPTION

This disclosure describes methods, software, and systems for creating and maintaining a terminology dictionary for a given team or group of teams. In general, complex group projects can involve multiple components, procedures, and systems that each have unique names and associated terminology. However, ambiguity in language and term definition can result in wasted time and effort for improperly defined tasks due to confusions as miscommunications between project members can occur. One solution is to establish a dictionary or uniform terminology method, with agreed upon definitions prior to the commencement of significant work on a project. This solution is not practical and often is not successful because new terminology can arise during the course of the project. Further, the ambiguities may not be readily apparent, or noticed prior to them arising in a miscommunication. Finally, the process of generating and maintaining a project specific dictionary represents a time-consuming endeavor.

In general, this disclosure describes a solution using artificial intelligence (AI) models such as large language models to automatically extract terminology (e.g., terms that can be a single word or a phrase) from relevant documentation, generate a terminology dictionary, and bring conflicts (e.g., using different terms for the same concept or using the same term to refer to different concepts) or ambiguities to the attention of a user. This enables users to quickly and effectively develop the terminology dictionary that can be implemented within a project to reduce miscommunication and enhance efficiency.

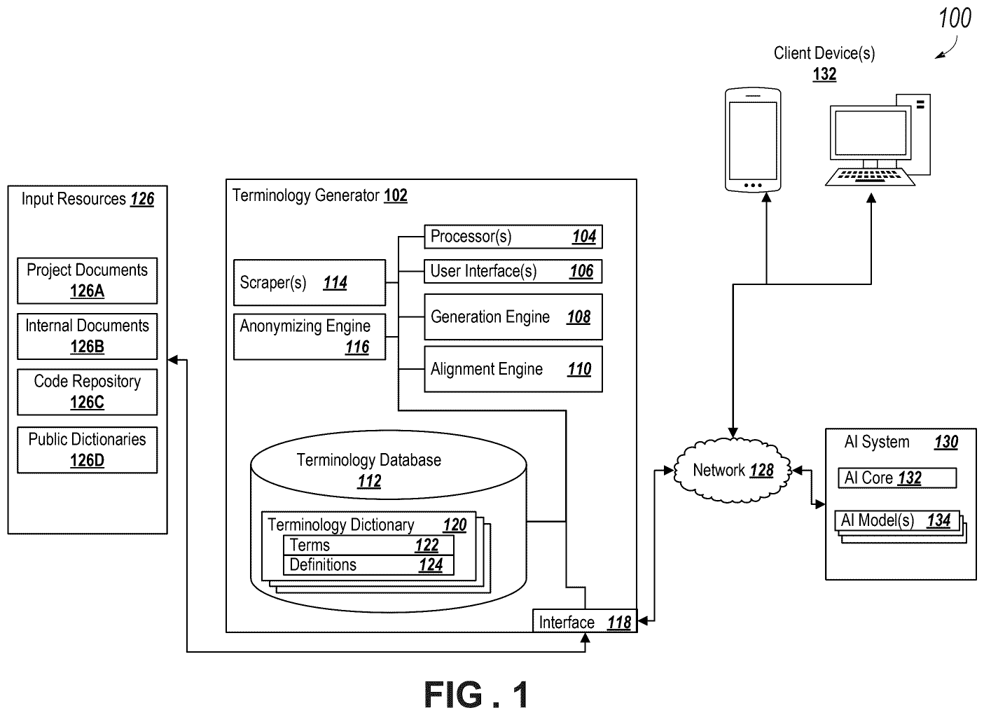

Turning to the illustrated example implementations, FIG. 1 illustrates a schematic diagram of a system 100 for building and storing a terminology dictionary. The system 100 includes a terminology generator 102, which consumes input resources 126 and uses an AI system 130 to generate and maintain a terminology database 112.

The terminology generator 102 includes one or more processors 104, user interfaces 106, a generation engine 108, an alignment engine 110, one or more scrapers 114, and an anonymizing engine 116. These components work in conjunction to generate and maintain the terminology database 112, which is a repository or file storage storing one or more dictionaries of terms and their definitions. In some instances, the terminology database 112 can be maintained outside of the terminology generator 102 and be communicatively coupled to the terminology generator 102, e.g., through the network 128, to query and obtain result data. In general, these components communicate via a network 128 using one or more interfaces 118.

The interface 118 can be used by the terminology generator 102 for communicating with other systems in a distributed environment - including within the system 100 - connected to the network 128, e.g., client 132, and other systems communicably coupled to the terminology generator 102 and/or network 128. Generally, the interface 118 comprises logic encoded in software and/or hardware in a suitable combination and operable to communicate with the network 128 and other components. More specifically, the interface 118 can comprise software supporting one or more communication protocols associated with communications such that the network 128 and/or interface's 118 hardware is operable to communicate physical signals within and outside of the illustrated system 100. Still further, the interface 118 can allow the terminology generator 102 to communicate with the client devices 132, input resources 126, and AI system 130, and/or other portions illustrated within the system 100 to perform the operations described herein.

The terminology generator 102 can include one or more processors 104 that can be used according to particular needs, desires, or particular implementations of the terminology generator 102 in the context of system 100 of FIG. 1. Each processor 104 can be a central processing unit (CPU), an application specific integrated circuit (ASIC), a field-programmable gate array (FPGA), or another suitable component. Generally, the processor 104 executes instructions and manipulates data to perform the operations of the terminology generator 102. Specifically, the processor 104 can execute one or more algorithms and operations according to implementations of the present disclosure, and as described in relation to the figures. In some instances, the processor 104 can be configured to execute operations of v various software modules and functionality, including the functionality for sending communications to and receiving transmissions from client devices 132, AI system 130, as well as to other devices and systems. Each processor 104 can have a single or multiple cores, with each core available to host and execute an individual processing thread. Further, the number of, types of, and particular processors 104 used to execute the operations described herein can be dynamically determined based on a number of requests, interactions, and operations associated with the terminology generator 102.

User interface(s) 106 are communicatively coupled with at least a portion of the system 100 for any suitable purpose, including generating a visual representation of any terminology dictionary 120 and/or the content associated with any components of the terminology generator 102 and providing that representation for viewing at a client device 132. In particular, the user interface 106 can be used to present results of a query executed at the terminology database 112 or allow the user to input a query or obtain response(s) to one or more prompts to the terminology generator 102, as well as to otherwise interact and present information associated with one or more applications. User interface 106 can also be used to view and interact with various web pages, applications, and web services located local or external to the client device 146. Generally, the user interface 106 can provide the user with an efficient and user-friendly presentation of data provided by or communicated within the system 100. The user interfaces 106 can include a plurality of customizable frames or views having interactive fields, pull-down lists, and buttons that can be operated by the user. In general, the user interface 106 is configurable, supporting a combination of tables and graphs (bar, line, pie, status dials, etc.), and is able to build real time portals, application windows, and presentations. Therefore, the user interface 106 contemplates any suitable graphical user interface, such as a combination of a generic web browser, a web-enable application, intelligent engine, and command line interface (CLI) that processes information in the platform and efficiently presents the results to the user visually.

Generation engine 108 consumes data from input resources 126, uses the input resources 126 into prompts and sends the prompts to the AI system 130. The generation engine 108 can then parse the obtained result from the AI system 130 to generate or modify a terminology dictionary 130 in the terminology database 112. Input resources 126 can be any suitable set of documents or information for a project (e.g., deployed project running on computer infrastructure or for a project in design and development, among other example projects). In general, the input resources 126 include project documents comprising at least one of: planning documents and schematics, specification sheets or requirement listings, data in tables, project memorandums or descriptions, white papers, or other types of documents.

In some instances, input resources 126 can include internal documents, which can be related to a company or organization and can use terminology not published outside of the company or organization. In some instances, the input resources 126 can include documents associated with a category of projects 126A, e.g., design and development, architectural conception, testing, integration scenarios, user specification, etc., but not specific for a single project. The input resources 126 can be associated with different technical fields, including software development, product design and development, manufacturing, electrical engineering, telecommunications, computer system analytics, other. For example, internal documents 126B can include, but are not limited to company policy documents, architecture concept documents, architecture decision records, user interface design documents, defined company terminology, organizational goals or statements, project group goals, vision/project strategy, blog posts, tutorials, guide procedures, user documentation, administrator guide, or other documents. In some instances, the input resources 126 can be associated with a software development project and can include one or more code repositories 126C, which can include readme files, metadata files, code descriptions, the code itself, comments associated with the code. The input resources 126 may also include publicly available dictionaries, manuals, or technical documents 126D defining certain terms or phrases.

In some implementations, input resources 126 are categorized by project or assignment. In other words, each team or group generating a dictionary (e.g., for a given project) can have a unique set of input resources 126, or a set of input resources 126 that is particularized to their specific field of endeavor. In some implementations, the input resources 126 include a skip list or list of terms that should not be defined or included in a term dictionary. For example, terms that have a commonly agreed upon universal definition, or are otherwise ambiguous. In another example, terms that are proper nouns, hybrid words, or intentionally fanciful or arbitrary words (e.g., “Acura” or “Pepsi”). The skip list can prevent the terminology generator 102 from expending resources defining terms that are not wanted or not necessary for the terminology dictionary 120.

The terminology generator 102 can access input resources 126 using one or more data scrapers 114. The data scrapers 114 can automatically extract information from the input resources to be converted to a prompt for the AI system 130. In general, the data scrapers 114 can fetch data from the input resources 126, parse that data to extract specific information (e.g., text data, structured language data, etc.), format the data for consumption by the generation engine 108 and then store the data in a memory for retrieval by the generation engine 108. In some implementations he data scrapers 114 operate asynchronously with the generation engine 108, providing a stream of updated, new, or changing data from the input resources 126 over time.

The generation engine 108 can receive data from the scrapers 114 and convert it into a prompt for the AI system 130. For example, a document received may exceed the maximum prompt length available for the AI system 130, so the generation engine 108 can parse it into smaller portions and provide it sequentially. In general, the generation engine 108 creates a prompt for the AI system 130, which returns an output that is then stored in the terminology database 112 by the generation engine 108. For example, the generation engine can prompt: “Create a terminology list from the following text, provide descriptions in one sentence. (<text>).” Additional commands regarding format or context of the output can be given, for example: “Provide output in JSON format with the attributes {term, description, origin}.” Or in another example, “your terminology description should be in the style of a ‘technical expert.’” The AI system 130 will return an output (e.g., a JSON that includes a set of terms and their associated description/definition) and the generation engine 108 can store the output in the terminology database 112. An example output of the generation engine 108 might be: {“term”: “small transports”, “description”: “ABAP transports that contain a small number of objects”, “origin”: “Use Cases”}.

Terminology database 112 of the terminology generator 102 can represent a single memory or multiple memories. The terminology database 112 can include any memory or database module and can take the form of volatile or non-volatile memory including, without limitation, magnetic media, optical media, random access memory (RAM), read-only memory (ROM), removable media, or any other suitable local or remote memory component. The terminology database 112 can store various objects or data, including application data, user and/or account information, administrative settings, password information, caches, applications, backup data, repositories storing business and/or dynamic information, and any other appropriate information associated with the terminology generator 102, including any parameters, variables, algorithms, instructions, rules, constraints, or references thereto. Additionally, the terminology database 112 can store any other appropriate data, such as VPN applications, firmware logs and policies, firewall policies, a security or access log, print or other reporting files, as well as others. While illustrated within the terminology generator 102, terminology database 112 or any portion thereof, including some or all of the particular illustrated components, can be located remote from the terminology generator 102 in some instances, including as a cloud application or repository. In those instances, the data stored in terminology database 112 can be accessible, for example, via one of the described applications or systems.

In some instances, terminology database 112 includes a number of terminology dictionaries 120, each terminology dictionary including a set of terms 122 and definitions of those terms 124. In some implementations, each terminology dictionary 120 is associated with a particular project. For example, an enterprise software search improvement program could have one terminology dictionary 120, while a business development team may have a separate terminology dictionary 120. In some implementations, each of the terms 122 include a status value, e.g., “new,” “consensus,” “conflicting,” “external,” “approved,” “undesired”, “discarded” or other. These statuses can be used by the generation engine 108 and the alignment engine 110 in maintenance of the database. For example, the alignment engine can periodically check for “new” terms to assess their associated definitions 124 and determine whether a conflict exists. Similarly, the alignment engine 110 can periodically send “conflicting” status terms 120 to a client device 132 to receive user input and a resolution on the conflict. In some implementations, each terminology dictionary 120 is stored as a structured object, with an array of key value pairs, where the keys are the terms, and the values are their definitions. This storage structure provides for simple searching and querying of the terminology dictionary 120.

The alignment engine 110 ensures consistency and is used to resolve conflicts in the terminology dictionary 120. The alignment engine 110 can analyze the terminology dictionaries 120 and find inconsistent terms, or terms with the semantically similar definitions that have the potential to give rise to confusion. For example, the terms “edit” and “modify” might have similar meanings, and thus might cause confusion where one team member uses the term “edit” and another team member uses the term “modify.”

In some instances, to unify similar terms in an attempt to resolve possible issues that may arise from the use of different words or phrases for the same concept in documents (e.g., technical documents), the alignment engine 110 can generate a prompt for the AI system 130 to create a new term or a “consensus term” that can be a hybrid of both the terms that encompasses both the terms. In some implementations, the consensus term can be a selection of one of the two terms. For instance, in the previous example, the alignment engine 110 can select the term “edit” and recommend that appearances of the term “modify” in the input resources 126 be considered for replacement with the term “edit.” In some implementations, a hybrid definition, or consensus definition is generated by prompting the AI system 130. For example, the system can be prompted with “create a consensus definition for the term ‘<term>’, given by these two descriptions <desc. 1>, <desc. 2>.” Where the two descriptions are the previously generated definitions for the similar terms.

In some instances, the alignment engine 110 can analyze for conflicting terms, or terms where multiple definitions are given to the same term. For example, the term “bay” may simultaneously be defined as “a broad inlet of the sea where the land curves inward” and “a horse with reddish-brown body and black markings on its points.” The alignment engine can identify these conflicts and resolve them automatically based on the input resources 126 or provide the conflict to a client device 132 via the user interface 106 for user resolution. The conflict can be resolved, for example, by a context document provided in the input resources 126, identifying a particular context for the dictionary 120 being analyzed (e.g., equestrian, and not geographic). In some implementations, this is resolved using the AI system 130, for example, a prompt can be “which of the two following definitions is more applicable to the project described in <input resource>. <definition 1>, <definition 2>.”

In some instances, an anonymizing engine 116 can scan input resources 126, and scrub or mask personal information from the resources before those are provided to the generation engine. This can provide for enhanced security and privacy. In some implementations the anonymizing engine 116 operates in parallel, or separately from the remaining components of terminology generator 102.

The AI system 130 enables other engines and applications to interact with one or more AI models 134 in a secure manner. That is, the AI system 130 generally provides access to large-scale third-party models, while ensuring that data used in prompting those models, or training new models remains in the custody of the terminology generator 102. The AI system 130 can include an AI core 132 which manages prompts and training commands amongst an array of hosted AI models 134.

The AI core 132 can constrain the AI models 134 by grounding their outputs to ensure they do not provide hallucinations. This can be accomplished, for example, with prompt engineering, in-context learning, and retrieval-augmented generation (RAG).

The AI models 120 can be foundation models that are used to generate a response to a given prompt. In some implementations, foundation models are large AI neural networks trained on large sets of unlabeled data, often through self-supervised learning. These models, once trained, can perform specific tasks such as image classification, natural language processing, question answering, or embedding. Embedding, for example, is generating a numerical representation of data in a lower-dimensional space to convert complex information such as text, images, or audio, into a format that is more efficiently processed by computers. Example AI models 120 can include, but are not limited to, large language models (LLMs), Bidirectional encoder representations from Transformers (BERT), or other transformer-based networks.

The AI models 120 can be provided by a third party or external source, such as OpenAI, or Google, which can provide a base model with some foundational training. In some implementations, the AI core 132 enables users of the terminology generator 102 to provide their own AI models 120. In some implementations, a model of the AI model(s) 120 can be further training or fine-tuned to provide an optimized model version adjusted to the terminology generator 102 when providing services to end users to generate terminology dictionaries, such as the terminology dictionary 120. The further training or fine-tuning can be performed for a particular context or given field, such as software development projects and/or particular organization. The further training or fine-tuning can be performed on a specific training data set and/or restrained based on custom criteria.

As illustrated, one or more client devices 132 can be part of the system 100. The client devices 132 can be any computing devices operable to communicate with the terminology generator 102, other client devices 132, and/or other components via network 128, as well as with the network 128 itself, using a wireline or wireless connection. Each client devices 132 can be associated with one or more users. The client devices 132 is intended to encompass any computing device such as a desktop computer, laptop/notebook computer, mobile device, smartphone, personal data assistant (PDA), tablet computing device, one or more processors within these devices, or any other suitable processing device. In general, the client devices 132 and its components can be adapted to execute any operating system, including Linux, UNIX, Windows, Mac OS®, Java™, Android™, or iOS. In some instances, the client devices 132 can comprise a computer that includes an input device, such as a keypad, touch screen, or other device(s) that can interact with one or more client applications, such as one or more dedicated mobile applications, and an output device that conveys information associated with the operation of the applications and their application windows to the user of the client devices 132. Such information can include digital data, visual information, which can be displayed on a display such as user interface 106. In some implementations, when terms 120 are displayed at the client 132, they can be displayed with a link (e.g., a uniform resource locator) to the associated input resource(s) 126 that includes the term 122.

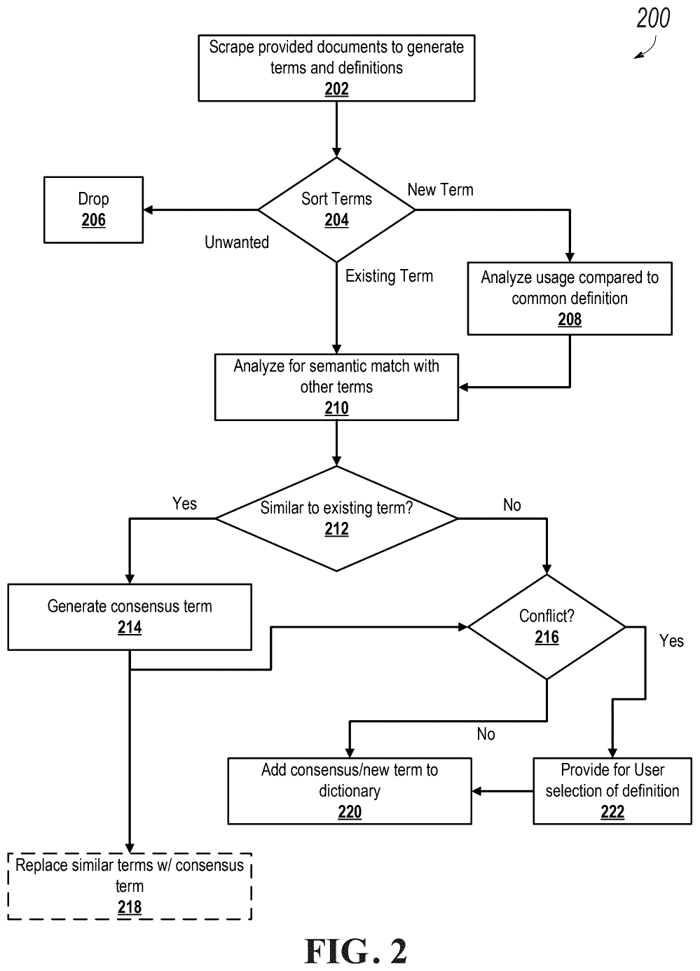

FIG. 2 is a flowchart of an example process 200 for building and storing a terminology dictionary. It will be understood that process 200 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 200. In some implementations, the process 200 and related methods are executed by one or more components of the system 100 described above with respect to FIG. 1, such as the terminology generator 102 and the customer AI system 130, and/or portions thereof.

At 202, provided documents are scraped and parsed in order to generate a list of terms and definitions for those terms. In some implementations, a scraper extracts text information from websites, documents, and other input resources, and provides them to a terminology generator which parses the text into prompts suitable for an AI model such as a large language model (LLM), and provides the prompts to the AI model. The AI model can return a list of terms and associated definitions or descriptions.

At 204, the terms are sorted based on whether they are new, existing, or unwanted. In some implementations, a blacklist, or a list of unwanted terms can be provided which can include terms that are not applicable to the dictionary being created, or otherwise are not suitable. In some implementations, this list of unwanted terms is provided by a user, or based on previous sorting events and user inputs. In some implementations, the unwanted terms are selected based on some criteria, such as that it does not meet a minimum threshold of usage within the input documents, or the AI model is unable to provide a coherent description of the term. At 206, any unwanted terms are removed from the dictionary.

At 208, upon sorting, new terms are analyzed to determine whether there is an existing match with other terms in either definition or term name. Additionally, during analysis of the new terms, the definitions of the new terms can be compared to common definitions, to analyze whether this term has been suitably defined, or whether a conflict has been created. In some implementations, a definition of the new term based on its usage in the input documents is compared to a definition from external sources (e.g., public dictionaries, internet scraping, etc.) and given a score or rating. In some implementations, if the score or rating is below a predetermined threshold, that is, if the new word has a description or definition that deviates significantly from the common meaning or usage, a warning or prompt can be sent to a user. In some implementations, if the definition deviates significantly, that term can be given a status such as “review” to ensure that its meaning and usage in the input documents is reconsidered in the future.

At 210, existing and new terms are analyzed to determine if their definitions are semantically matched or similar to any other term within the dictionary. A semantic match, or semantically similar can be determined, for example, by performing an embedding of each term and definition and then performing a proximity search or analysis algorithm such as Euclidean distance searches, maximal marginal relevance (MMR) searching, reciprocal rank fusion (RRF) searching, or other algorithms.

At 212, it is determined whether there are any terms that have a similar definition to other terms within the dictionary. If a term is identified as similar with another term, at 214, a consensus term is generated using a generative AI to resolve the conflict. In this manner, more consistent terminology can be created, minimizing the use of multiple terms with the same or substantially the same meaning. Once a consensus term is generated, or if there are no similar existing terms, at 216, an analysis is performed to determine whether there are conflicting terms. That is, a term with more than one definition. Or is otherwise used in different, conflicting ways in the input documents, that conflict can be flagged.

At 218, optionally, the similar terms used in the input documents can be automatically replaced by consensus terms generated at 214. In some implementations, this is performed by prompting an AI model. For example, an AI model can be prompted “replace the term ‘edit’ with the term ‘modify’ in the following documents. In some implementations, manual user review and approval can be requested to ensure that the semantic intend of the documents remains unchanged.

At 220, if no conflict was identified for a term in 216, the term is added as a new term, or the term is added as a consensus term (instead of identified terms similar to each other as at 212) to the dictionary. In some implementations, each term is stored as a key value pair with a definition (or description), where the definition is the value and the term itself is the key. In these implementations, each term is unique (key), and has a singular meaning (value). In some implementations, additional data is stored with each term, such as a status (e.g., “new”, “conflict resolved,” etc.) and a version history (e.g., “edit replaced with modify,” or “conflicted with geographic context, resolved in favor of equestrian context”).

At 222, if a conflict was identified where a term has multiple definitions, the multiple definitions can be provided to a user for selection of the correct definition. In some implementations, this process is performed by sending a notification or prompt to a user device with the two conflicting definitions and requesting that the user select the appropriate definition. In some implementations, the prompt is presented in a UI that includes links or access to the input documents used in generating the definitions. The user can review and select the most appropriate definition to resolve the conflict. In some implementations, the user can propose a new definition which can be analyzed by the terminology generator and incorporated into the dictionary. In some implementations where there is a conflict, one or more AI models are used to resolve the conflict instead of a user selection. For example, the AI model can analyze the context of the input documents and assign varying definitions respective weighted scores by prioritizing documents that are specific to the project for which the dictionary is being made over general documents or external documents.

The generated dictionary can be used, for example, for providing a unified lexicon for terminology within a project or team setting. For example, a communications handbook or instruction manuals can be promulgated with the dictionary, to ensure teamwide consistent usage, minimizing miscommunications and wasted efforts/time. In some implementations, the generated dictionary can be provided as input to an AI model when generating documentation for a project or topic. In this manner, the desired terminology can automatically be imbedded within a project's documentation.

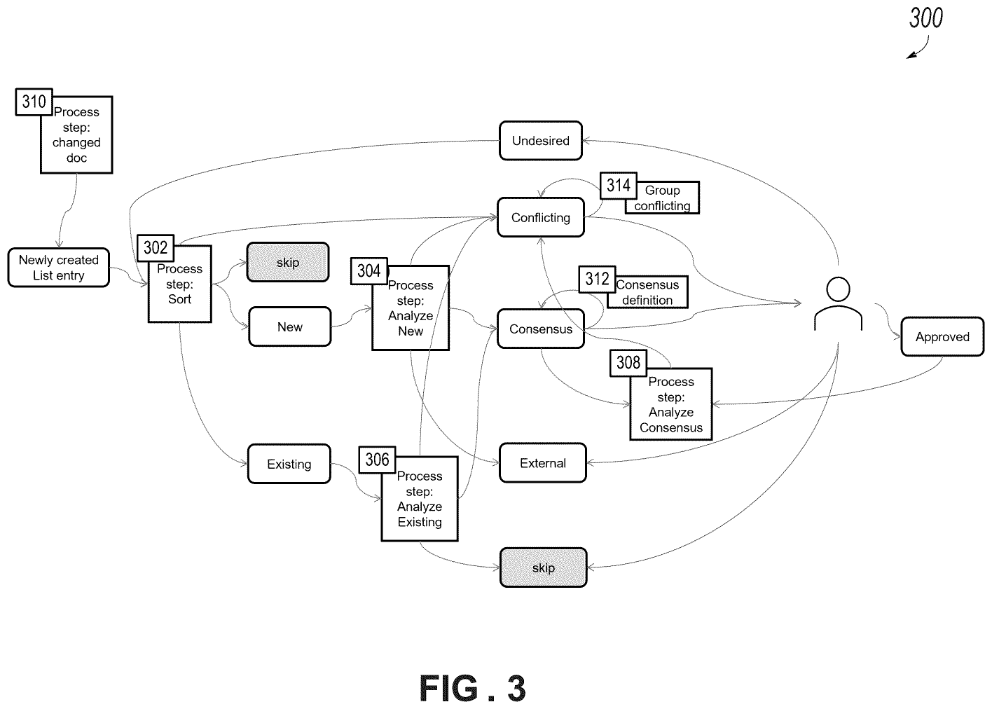

FIG. 3 is a flowchart of an example process 300 for building and storing a terminology dictionary. It will be understood that process 300 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 300. In some implementations, the process 300 and related methods are executed by one or more components of the system 100 described above with respect to FIG. 1, such as the terminology generator 102 and the customer AI system 130, and/or portions thereof.

At 302, newly identified terms from a set of input resources are sorted into categories including discarded, new, conflicting, and existing. Discarded terms are terms that have been identified as not to be added to the dictionary, and no further analysis is performed on them. The discarded terms are skipped and/or removed from the terminology dictionary. New terms are processed at 304 below as “analyze new.” Conflicting terms are tagged as a “conflict (type: deviating descriptions found)” and stored for future conflict resolution. Existing terms are terms that are already in the terminology dictionary and are submitted for analysis at 306.

At 304, a term definition for a new term, as identified at 302, is compared with external sources, such as the Internet, dictionaries, or other references and it is determined whether the term definition is consistent with external definitions, deviates from external definitions, or is not found. This determination can be made using an AI model such as an LLM, with a prompt. For example, the prompt might state: “Compare the term with the definition on the internet in the context of <project domain>. Does the term definition deviate from the common definition on the internet? (<term>, <definition>).” If the term is classified as being in consensus with the external definition, the term is tagged as an external term. If the term deviates from the external definition, it is tagged as “conflict (type: deviate from external).” If the term is not found in the external resources, it is tagged as a consensus term.

At 306, existing terms are analyzed similarly to 304. An AI model (e.g., an LLM such as GPT 3.5, Gemini, or other) is prompted and is used to compare the definition of an existing term with other tagged terms. If the term's definition matches the definition for a term with the external tag, approved tag, or consensus tag, no further processing is performed. If the term deviates from any of the tagged groups, it is tagged as conflicting, with a type indicating with which group it conflicts. In addition to being tagged as conflicting, a conflict type can be determined and added to the tag. An example prompt for the AI model to perform this analysis is “Do these two definitions of the term “<term>” differ significantly or are they semantically the same? (<term>, <definition1>), (<term>, <definition2>).”

At 308, terms in the dictionary that are tagged as consensus terms are analyzed. These terms are searched within a terminology dictionary and compared with terms tagged as approved. If there is a term with the consensus tag that matches a term with an approved tag, it is tagged as “conflicting (type: same definition as term with other name in approved)”.

In some implementations, a user can review and consider each term tagged as “consensus.” The user can sort these terms into the “approved” tag, or the “discarded” tag. The user can similarly review terms tagged as conflicting, which can include reviewing the source documentation showing deviating term usage.

At 310, optionally, when an input resource is changed, and newly created list entries are made, process 300 can be repeated partially or completely. In some implementations, this process 300 can be automated (e.g., via the use of data scraping and application programming interface (API)) and thus the terminology dictionary can be automatically updated, e.g., in response to providing a new input document for generating new terms, directly providing new terms, or updating the data in the terminology dictionary (e.g., modify a term or a definition that are existing in the dictionary), evolving over time, e.g., as a project progresses.

At 312, hybrid consensus definitions can be generated for terms with similar semantic meanings. These terms can be automatically generated and submitted to the user for approval.

At 314, when groups of terms conflict, they entire group can be analyzed by the AI model, and a proposed conflict resolution can be generated and presented to the user for approval.

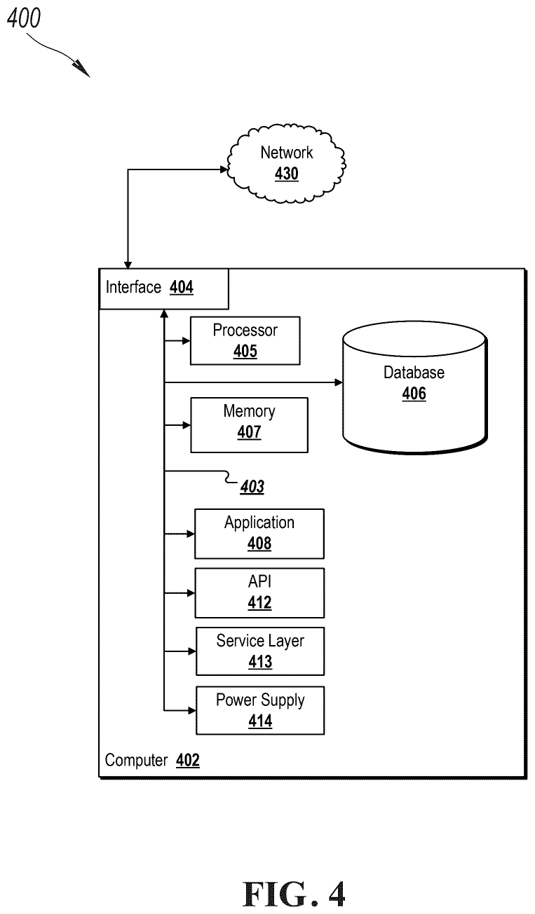

FIG. 4 is a block diagram illustrating an example of a computer-implemented system. 400 used to provide computational functionalities associated with described algorithms, methods, functions, processes, flows, and procedures, according to an implementation of the present disclosure. In the illustrated implementation, system 400 includes a computer 402 and a network 430.

The computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the computer 402 can include an input device, such as a keypad, keyboard, or touch screen, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a distributed computing system as, for example, a client, network component, a server, or a database or another persistency, or a combination of roles for performing the subject matter described in the present disclosure. The illustrated computer 402 is communicably coupled with a network 430. In some implementations, one or more components of the computer 402 can be configured to operate within an environment, or a combination of environments, including cloud-computing, local, or global.

At a high level, the computer 402 is an electronic computing device operable to receive, transmit, process, store, or manage data and information associated with the described subject matter. According to some implementations, the computer 402 can also include or be communicably coupled with a server, such as an application server, e-mail server, web server, caching server, or streaming data server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users (for example, from a command console or by another internal access method), external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using the service layer 413. Software services, such as those provided by the service layer 413, provide reusable, defined functionalities through a defined interface. For example, the interface can be software written in a computing language (for example, JAVA or C++) or a combination of computing languages, and providing data in a particular format (for example, extensible markup language (XML)) or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and includes logic encoded in software, hardware, or a combination of software and hardware. More specifically, the interface 404 can include software supporting one or more communication protocols associated with communications such that the network 430 or hardware of interface 404 is operable to communicate physical signals within and outside of the illustrated computer 402.

The computer 402 includes a processor 405. Although illustrated as a single processor 405, two or more processors 405 can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory or conventional database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. The database 406 can hold any data type necessary for the described solution.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

A number of implementations of the present disclosure have been described. Nevertheless, it will be understood that various modifications may be made without departing from the spirit and scope of the present disclosure. Accordingly, other implementations are within the scope of the following claims.

In view of the above described implementations of subject matter this application discloses the following list of examples, wherein one feature of an example in isolation or more than one feature of said example taken in combination and, optionally, in combination with one or more features of one or more further examples are further examples also falling within the disclosure of this application.
Example 1. A computer implemented method for building a terminology dictionary comprising: providing one or more documents to a generative artificial intelligence (AI) model for analysis; obtaining, using the generative AI model, a set of terms extracted from the one or more provided documents; generating, using the generative AI model, a definition for each term of the set of terms; identifying, using the generative AI model, two or more similar terms from the set of terms based on identifying semantic similarity between respective definitions of the two or more similar terms; generating, using the generative AI model, a consensus term for the identified two or more similar terms and a definition for the generated consensus term, the definition being generated based on the respective definitions of the two or more similar terms; and providing the consensus term and the definition for the generated consensus term to store in the terminology dictionary.
Example 2. The method of example 1, wherein a term of the extracted set of terms from the one or more provided documents is associated with at least two generated definitions, and wherein the method comprises: identifying, using the generative AI model, the term as a conflicting term based on identifying that the at least two generated definitions are conflicting term definitions; providing the identified conflicting terms to a user system for user review; and receiving, from the user system, a selection of a consensus term definition of the at least two generated definitions for providing the term with the consensus term definition to store in the terminology dictionary.
Example 3. The method of claim 2, comprising: identifying one or more particular documents of the one or more documents, the one or more particular documents comprising the identified conflicting term, wherein the one or more particular documents are associated with one or more definitions of the conflicting term that does not correspond to the selected consensus term definition; and providing the one or more particular documents to the user system for user review.
Example 4. The method of any of the previous examples, wherein obtaining the set of terms extracted from the one or more provided documents comprises: sorting extracted terms from the one or more provided documents based on comparing the extracted terms with terms already stored at the terminology dictionary into a category from a group consisting of new, existing, or discarded; and determining the set of terms to be those of the extracted terms that are categorized as new.
Example 5. The method of example 4, wherein new terms are terms that do not previously exist in the terminology dictionary, existing terms are terms that already exist in the terminology dictionary, and discarded terms are terms that are not provided for generation of a definition or considered for storing in the terminology dictionary.
Example 6. The method of any of the previous examples, wherein the generative AI model is a large language model.
Example 7. The method of any of the previous examples, wherein generating the definition for each term in the set of terms is based on an output of the generative AI model as trained on, internet search, and each term as applied in the one or more provided documents.
Example 8. The method of any of the previous examples, wherein the identified two or more similar terms are replaced by the consensus term in the provided documents.
Example 9. A non-transitory computer-readable medium coupled to one or more processors and having instructions stored thereon which, when executed by the one or more processors, cause the one or more processors to perform operations according to any one of examples 1 to 8.
Example 10. A system comprising a computing device; and a computer-readable storage device coupled to the computing device and having instructions stored thereon which, when executed by the computing device, cause the computing device to perform operations according to any one of examples 1 to 8.

1. A computer-implemented method for building a terminology dictionary, the method comprising:
providing one or more documents to a generative artificial intelligence (AI) model for analysis;
obtaining, using the generative AI model, a set of terms extracted from the one or more provided documents;
generating, using the generative AI model, a definition for each term of the set of terms;
identifying, using the generative AI model, two or more similar terms from the set of terms based on identifying semantic similarity between respective definitions of the two or more similar terms;
generating, using the generative AI model, a consensus term for the identified two or more similar terms and a definition for the generated consensus term, the definition being generated based on the respective definitions of the two or more similar terms; and
providing the consensus term and the definition for the generated consensus term to store in the terminology dictionary.

2. The method of claim 1, wherein a term of the extracted set of terms from the one or more provided documents is associated with at least two generated definitions, and wherein the method comprises:
identifying, using the generative AI model, the term as a conflicting term based on identifying that the at least two generated definitions are conflicting term definitions;
providing the identified conflicting terms to a user system for user review; and
receiving, from the user system, a selection of a consensus term definition of the at least two generated definitions for providing the term with the consensus term definition to store in the terminology dictionary.

3. The method of claim 2, comprising:
identifying one or more particular documents of the one or more documents, the one or more particular documents comprising the identified conflicting term, wherein the one or more particular documents are associated with one or more definitions of the conflicting term that does not correspond to the selected consensus term definition; and
providing the one or more particular documents to the user system for user review.

4. The method of claim 1, wherein obtaining the set of terms extracted from the one or more provided documents comprises:
sorting extracted terms from the one or more provided documents based on comparing the extracted terms with terms already stored at the terminology dictionary into a category from a group consisting of new, existing, or discarded; and
determining the set of terms to be those of the extracted terms that are categorized as new.

5. The method of claim 4, wherein new terms are terms that do not previously exist in the terminology dictionary, existing terms are terms that already exist in the terminology dictionary, and discarded terms are terms that are not provided for generation of a definition or considered for storing in the terminology dictionary.

6. The method of claim 1, wherein the generative AI model is a large language model.

7. The method of claim 1, wherein generating the definition for each term in the set of terms is based on an output of the generative AI model as trained on, internet search, and each term as applied in the one or more provided documents.

8. The method of claim 1, wherein the identified two or more similar terms are replaced by the consensus term in the provided documents.

9. A non-transitory computer-readable storage medium coupled to one or more processors and having instructions stored thereon which, when executed by the one or more processors, cause the one or more processors to perform operations for building a terminology dictionary, the operations comprising:
providing one or more documents to a generative artificial intelligence (AI) model for analysis;
obtaining, using the generative AI model, a set of terms extracted from the one or more provided documents;
generating, using the generative AI model, a definition for each term of the set of terms;
identifying, using the generative AI model, two or more similar terms from the set of terms based on identifying semantic similarity between respective definitions of the two or more similar terms;
generating, using the generative AI model, a consensus term for the identified two or more similar terms and a definition for the generated consensus term, the definition being generated based on the respective definitions of the two or more similar terms; and
providing the consensus term and the definition for the generated consensus term to store in the terminology dictionary.

10. The medium of claim 9, wherein a term of the extracted set of terms from the one or more provided documents is associated with at least two generated definitions, and wherein the operations comprise:
identifying, using the generative AI model, the term as a conflicting term based on identifying that the at least two generated definitions are conflicting term definitions;
providing the identified conflicting terms to a user system for user review; and
receiving, from the user system, a selection of a consensus term definition of the at least two generated definitions for providing the term with the consensus term definition to store in the terminology dictionary.

11. The medium of claim 10, the operations comprising:
identifying one or more particular documents of the one or more documents, the one or more particular documents comprising the identified conflicting term, wherein the one or more particular documents are associated with one or more definitions of the conflicting term that does not correspond to the selected consensus term definition; and
providing the one or more particular documents to the user system for user review.

12. The medium of claim 9, wherein obtaining the set of terms extracted from the one or more provided documents comprises:
sorting extracted terms from the one or more provided documents based on comparing the extracted terms with terms already stored at the terminology dictionary into a category from a group consisting of new, existing, or discarded; and
determining the set of terms to be those of the extracted terms that are categorized as new.

13. The medium of claim 12, wherein new terms are terms that do not previously exist in the terminology dictionary, existing terms are terms that already exist in the terminology dictionary, and discarded terms are terms that are not provided for generation of a definition or considered for storing in the terminology dictionary.

14. The medium of claim 9, wherein the generative AI model is a large language model.

15. The medium of claim 9, wherein generating the definition for each term in the set of terms is based on an output of the generative AI model as trained on, internet search, and each term as applied in the one or more provided documents.

16. The medium of claim 9, wherein the identified two or more similar terms are replaced by the consensus term in the provided documents.

17. A system, comprising:
one or more computers; and
a computer-readable storage device coupled to the one or more computers and having instructions stored thereon which, when executed by the one or more computer, cause the one or more computers to perform operations for building a terminology dictionary, the operations comprising:
providing one or more documents to a generative artificial intelligence (AI) model for analysis;
obtaining, using the generative AI model, a set of terms extracted from the one or more provided documents;
generating, using the generative AI model, a definition for each term of the set of terms;
identifying, using the generative AI model, two or more similar terms from the set of terms based on identifying semantic similarity between respective definitions of the two or more similar terms;
generating, using the generative AI model, a consensus term for the identified two or more similar terms and a definition for the generated consensus term, the definition being generated based on the respective definitions of the two or more similar terms; and
providing the consensus term and the definition for the generated consensus term to store in the terminology dictionary.

18. The system of claim 17, wherein a term of the extracted set of terms from the one or more provided documents is associated with at least two generated definitions, and wherein the method comprises:
identifying, using the generative AI model, the term as a conflicting term based on identifying that the at least two generated definitions are conflicting term definitions;
providing the identified conflicting terms to a user system for user review; and
receiving, from the user system, a selection of a consensus term definition of the at least two generated definitions for providing the term with the consensus term definition to store in the terminology dictionary.

19. The system of claim 18, wherein the computer-readable storage device further stores instructions, which when executed by the one or more computers, cause the one or more computers to perform operations comprising:
identifying one or more particular documents of the one or more documents, the one or more particular documents comprising the identified conflicting term, wherein the one or more particular documents are associated with one or more definitions of the conflicting term that does not correspond to the selected consensus term definition; and
providing the one or more particular documents to the user system for user review.

20. The system of claim 17, wherein obtaining the set of terms extracted from the one or more provided documents comprises:
sorting extracted terms from the one or more provided documents based on comparing the extracted terms with terms already stored at the terminology dictionary into a category from a group consisting of new, existing, or discarded; and
determining the set of terms to be those of the extracted terms that are categorized as new.
